(19) United States
(12) Patent Application Publication
(10) Pub. No.: US 2025/0173761 A1
(43) Pub. Date: May 29, 2025

(54) METHOD OF PROVIDING INFORMATION AND VEHICLE PERFORMING SAME

(71) Applicants: Hyundai Motor Company, Seoul (KR); Kia Corporation, Seoul (KR)

(72) Inventor: Gyu Young LEE, Yongin-si (KR)

(73) Assignees: Hyundai Motor Company, Seoul (KR); Kia Corporation, Seoul (KR)

(21) Appl. No.: 18/795,991

(22) Filed: Aug. 6, 2024

(30) Foreign Application Priority Data
Nov. 28, 2023 (KR) 10-2023-0168473

(51) Int. Cl. G06Q 30/0251; G06V 20/59

(52) U.S. Cl. CPC G06Q 30/0265; G06V 20/59

(57) ABSTRACT

Disclosed are an information provision method and a vehicle for providing advertising information for occupants in each vehicle and advertising information for all occupants in vehicles participating in group driving based on occupants in each vehicle, the total number of occupants in vehicles participating in group driving, a shared destination or route, advertising products for each number of occupants registered by affiliated stores in a server, and the like in when a plurality of vehicles participates in group driving.

### CROSS-REFERENCE TO RELATED APPLICATION

The present application claims priority to Korean Patent Application No. 10-2023-0168473, filed on Nov. 28, 2023, the entire contents of which is incorporated herein for all purposes by this reference.

### BACKGROUND OF THE PRESENT DISCLOSURE

### Field of the Present Disclosure

The present disclosure relates to an information provision method for providing information to occupants of a vehicle and a vehicle that performs the same.

### Description of Related Art

A conventional navigation system provided in a vehicle utilizes information received from global positioning system (GPS) satellites, displays a current location and traveling direction of the vehicle on a display, and when a destination is input, displays roads, a distance, and an estimated time required for the vehicle to reach the destination on the screen based on the current location.

This route display function provides more optimized route information using real-time traffic information and also provides a multimedia content playback function.

As users spend a longer time in vehicles, functions for increasing user convenience using a navigation system, for example, a function of providing advertising information on businesses near a route, may be provided.

As such advertising information, advertising information determined based on each vehicle is provided in general. Even in the case of group driving in which a plurality of vehicles utilizes a shared destination or route, advertising information based on the number of people in each vehicle rather than the total number of occupants in vehicles participating in group driving is generally provided.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing more appropriate advertising information that takes occupants into consideration in the case of group driving of a plurality of vehicles by providing advertising information based on the number of occupants in each vehicle and advertising information based on the total number of occupants of group driving.

The objects to be achieved in an exemplary embodiment of the present disclosure are not limited to the objects mentioned above, and other objects not mentioned will be clearly understood by those skilled in the art from the description below.

In accordance with an aspect of the present disclosure, the above and other objects may be accomplished by the provision of a method of providing information to a vehicle participating in group driving of a plurality of vehicles, including transmitting information on occupants to a server, receiving advertising information based on information on occupants in a plurality of vehicles participating in group driving from the server, and outputting the received advertisement information through an output device.

For example, the method may further include collecting information on occupants for a corresponding vehicle through a vehicle sensor after the vehicle participates in group driving, and the information on occupants may include information collected through the vehicle sensor.

For example, the outputting of the advertising information through the output device may include separately outputting advertisement information for occupants in each vehicle and advertisement information for all occupants in the vehicles participating in the group driving.

In accordance with another aspect of the present disclosure, there is provided a method of providing information, including receiving, by a server, occupant information from each of vehicles participating in group driving, and transmitting advertising information determined based on the received occupant information to the plurality of vehicles.

For example, the method may further include summing numbers of occupants in the plurality of vehicles participating in the group driving and determining advertising information for occupants in each vehicle and advertising information for all occupants in the vehicles participating in the group driving based on a number of occupants in each vehicle after the receiving of the occupant information from each of the vehicles participating in the group driving.

For example, the method may further include determining the advertising information based on a destination or a route shared through the group driving after the receiving of the occupant information from each of the vehicles participating in the group driving.

For example, the method may further include determining the advertisement information based on advertisement products for each piece of occupant information registered by each affiliated store in the server after the receiving of the occupant information from each of the vehicles participating in the group driving.

In accordance with another aspect of the present disclosure, there is provided a vehicle including an output device, and a controller configured to transmit information on occupants in the vehicle to a server in response that the vehicle participates in group driving, receive advertising information based on information on occupants in vehicles participating in the group driving from the server, and perform control so that the received advertising information is output through the output device.

For example, the vehicle may further include a vehicle sensor, and the controller may collect the information on occupants through the vehicle sensor.

For example, the advertising information may be determined based on a destination or a route shared through the group driving.

For example, the advertising information may be determined based on advertising products for each piece of occupant information registered by affiliated stores in the server.

For example, the controller may perform control so that advertising information corresponding to occupants in each vehicle and advertising information corresponding to all occupants in the vehicles participating in the group driving are separately output through the output device.

In accordance with another aspect of the present disclosure, there is provided a server including a communication device, and a controller configured to, in response that a plurality of vehicles participates in group driving, receive information on occupants in each vehicle in the plurality of vehicles through the communication device, and perform control so that advertising information determined based on the received information on occupants is transmitted to the plurality of vehicles through the communication device.

For example, the controller may be configured to determine the advertisement information based on information on occupants in the plurality of vehicles participating in the group driving.

For example, the controller may be configured to determine the advertisement information based on a route or a destination shared by the vehicles participating in the group driving.

For example, the controller may separately determine advertising information corresponding to occupants in each vehicle and advertising information corresponding to all occupants in the vehicles participating in the group driving.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing a configuration of a vehicle according to an exemplary embodiment of the present disclosure;

FIG. 2 is a diagram illustrating operations of a vehicle and a server according to an exemplary embodiment of the present disclosure;

FIG. 3 is a flowchart showing an example of an information provision method of a vehicle according to an exemplary embodiment of the present disclosure;

FIG. 4 is a flowchart showing an example of an information provision method of a server according to an exemplary embodiment of the present disclosure; and

FIG. 5 is a diagram showing an example in which advertising information is displayed on an output device according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the following description of the exemplary embodiments disclosed in the present specification, a detailed description of known functions and configurations incorporated herein will be omitted when it may obscure the subject matter of the present disclosure. Furthermore, the accompanying drawings are provided only for ease of understanding of the exemplary embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

An element described in the singular form is directed to include a plurality of elements unless the context clearly indicates otherwise.

In the present specification, it will be further understood that the term “comprise” or “include” specifies the presence of a stated feature, figure, step, operation, component, part or combination thereof, but does not preclude the presence or addition of one or more other features, figures, steps, operations, components, or combinations thereof.

Hereinafter, various exemplary embodiments included in the present specification will be described in detail with reference to the appended drawings. Identical or similar components will be assigned the same reference numerals and redundant descriptions thereof will be omitted.

First, an object of the present disclosure is to provide advertising information based on the number of occupants in each vehicle and advertising information based on the total number of occupants in vehicles participating in group driving when a plurality of vehicles is participating in the group driving. Furthermore, in determining the advertising information, a destination and a route shared through the group driving and advertising products for each number of occupants registered by affiliated stores in a server may be additionally considered.

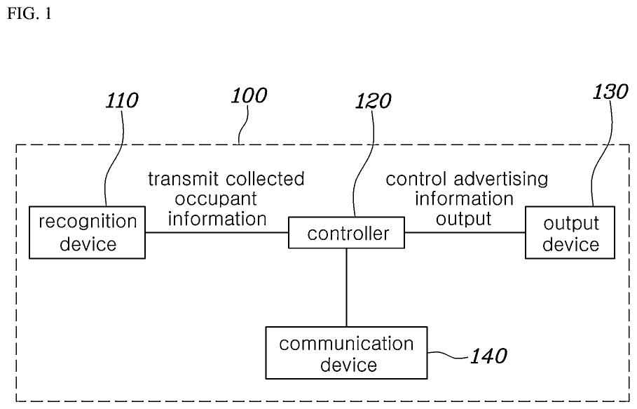

FIG. 1 is a diagram showing a vehicle according to an exemplary embodiment of the present disclosure.

Referring to FIG. 1, the vehicle 100 according to an exemplary embodiment of the present disclosure may include a recognition device 110, a controller 120, and an output device 130. FIG. 1 mainly shows components related to an exemplary embodiment of the present disclosure, and a real vehicle may include fewer or more components than these components.

Hereinafter, each component will be described.

The recognition device 110 may be provided in the internal space of the vehicle. For example, the recognition device 110 may include sensors such as a camera, a seat sensor, and a seat belt sensor provided in the internal space of the vehicle. However, this is an example and the present disclosure is not necessarily limited thereto.

The recognition device 110 can collect information on occupants in the vehicle. The collected information may be transmitted to the controller 120 operatively connected to the recognition device 110.

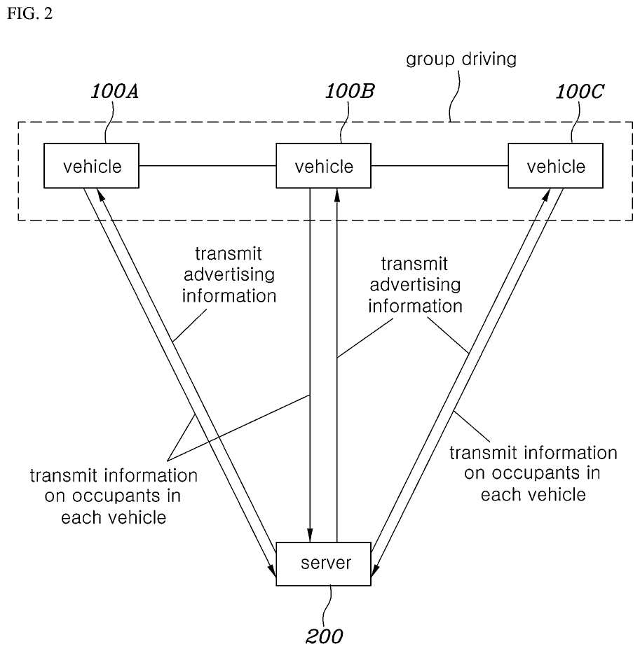

The controller 120 according to an exemplary embodiment of the present disclosure can perform control so that advertising information for each occupant in each vehicle participating in group driving and advertising information based on the total number of occupants of group driving are separately output through the output device 130. This will be described in detail later with reference to FIG. 2.

For example, the output device 130 may include a display device, a head-up display (HUD), a cluster, a speaker, a vibration device, or the like.

Meanwhile, in implementation of the controller 120 according to an exemplary embodiment of the present disclosure, the controller 120 may be implemented with a function of an audio/video/navigation (AVN) system provided in the vehicle. However, this is an example and the present disclosure is not necessarily limited thereto. For example, the controller 120 may be implemented as a separate controller from an AVN controller, or may be implemented so that functions thereof are distributed in two or more different controllers.

FIG. 2 is a diagram illustrating operations of a vehicle and a server according to an exemplary embodiment of the present disclosure.

In FIG. 2, it is assumed that three vehicles 100A, 100B, and 100C are participating in the group driving.

As described above, information collected through the recognition device 110 provided in each of the vehicles 100A, 100B, and 100C may be transmitted to a server 200 via a communication device 140 of each vehicle 100.

For example, the communication device 140 may include a cellular network, Wi-Fi, Bluetooth, and the like.

In an exemplary embodiment of the preset disclosure, the server 200 may include a communication unit and a controller including a processor and a memory.

The server 200 can determine the total number of occupants in vehicles participating in group driving by summing the received number of occupants in the vehicles. The server 200 may be configured to determine advertisement information for occupants in each vehicle and advertisement information for all occupants in vehicles participating in the group driving.

Here, in determining advertisement information, the server 200 may consider information received from the communication device 140 of each vehicle via the communication device of the server 200 and information such as the total number of occupants in vehicles participating in group driving determined by summing the information received from each vehicle. Additionally, the server may consider a route and a destination shared through the plurality of vehicles participating in group driving and also consider advertising products for each piece of information on occupants registered by affiliated stores in the server. Here, the information on occupants registered by the affiliated stores in the server may include the number, sexes, ages, and the like of occupants. However, the above consideration factors are illustrative and do not necessarily consider only the requirements limited thereto.

The determined advertising information may include advertising information for occupants in each vehicle and advertising information for the total number of occupants in vehicles participating in the group driving.

Upon receiving the advertising information for occupants in each vehicle and advertising information for the total number of occupants in vehicles participating in group driving from the server 200, the controller 120 of each of the vehicles 100A, 100B, and 100C may output the advertising information to the output device 130.

Here, the controller 120 of each of the vehicles 100A, 100B, and 100C may perform control so that the advertisement information for the occupants in each vehicle and the advertisement information for the total number of occupants in vehicles participating in group driving are separately displayed on the output device 130. To the present end, different pin shapes or colors may be used, but this is an example and the present disclosure is not limited thereto.

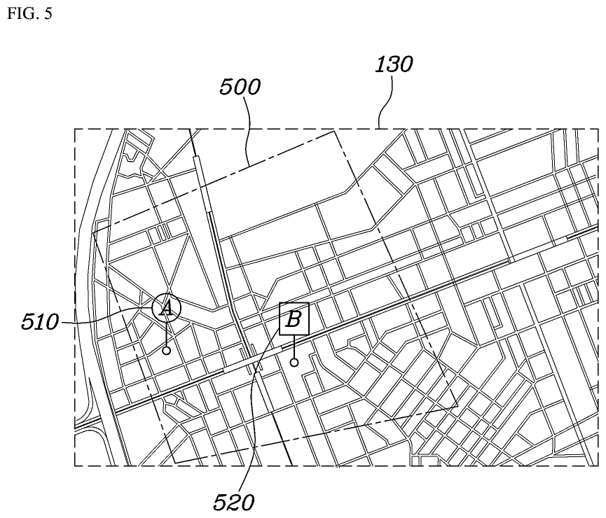

A specific form in which advertising information is displayed on the output device 130 according to an exemplary embodiment of the present disclosure will be described later with reference to FIG. 5.

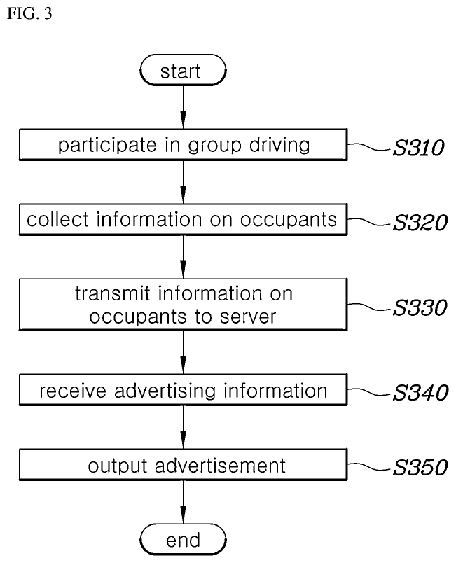

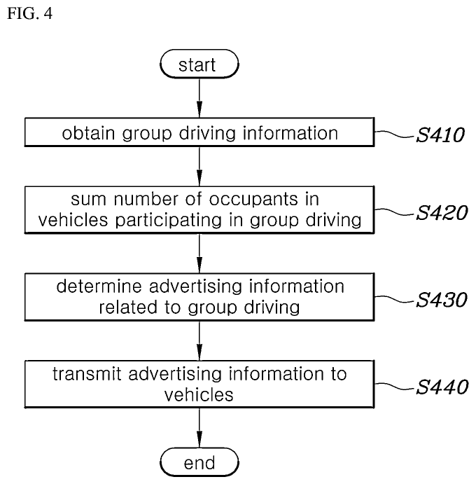

An example of the information provision process described above is summarized as flowcharts of FIG. 3 and FIG. 4.

FIG. 3 is a flowchart showing an example of an information provision method performed in a vehicle according to an exemplary embodiment of the present disclosure.

Referring to FIG. 3, when a plurality of vehicles participates in group driving (S310), each vehicle can collect information on occupants through vehicle sensors such as a camera, a seat sensor, and a seat belt sensor (S320).

Here, a specific method of participating in group driving may include notifying the server 200 of participation in group driving, by each of vehicles that wants to participate in group driving, or transmitting a group driving identifier to the server 200. However, this is an example and embodiments of the present disclosure are not limited by the type of group driving participation.

The information on occupants may include the number, sexes, ages, and the like of the occupants.

Each vehicle can transmit the information on occupants to the server (S330).

Each vehicle can receive advertising information from the server (S340). Here, the advertising information received by the vehicle from the server may be advertising information based on the number of occupants in each vehicle and advertising information based on the total number of occupants in vehicles participating in the group driving. Additionally, the advertising information may be advertising information that takes a destination and a route shared through the group driving into consideration, and may be advertising information that takes advertising products for occupants in each vehicle registered by affiliated stores in the server into consideration.

The received advertising information may include advertising information for the occupants in each vehicle and advertising information for the total number of occupants in vehicles participating in the group driving.

The vehicle can separately output an advertisement corresponding to occupants in each vehicle and an advertisement corresponding to all occupants in the group driving (S350). For example, the vehicle can display an advertisement corresponding to occupants each vehicle and an advertisement corresponding to all occupants in vehicles participating in group driving so that the advertisements may be distinguished for the occupants using pins in different shapes or different colors.

FIG. 4 is a flowchart showing an example of an information provision method of the server according to an exemplary embodiment of the present disclosure.

Referring to FIG. 4, upon acquisition of information on a plurality of vehicles participating in group driving (S410), the server can receive information on occupants in each vehicle participating in group driving (S420). The information on occupants may include the number, sexes, ages, and the like of occupants.

The server can determine advertisement information based on the number of occupants in each vehicle and advertisement information based on the total number of occupants in vehicles participating in group driving through the received information on occupants (S430).

In determining advertising information for occupants in each vehicle and advertising information for the total number of occupants in vehicles participating in group driving, the server may consider information on occupants in each vehicle participating in group driving and the total number of occupants in vehicles participating in the group driving. Furthermore, the server may consider a destination or a route shared through group driving, and advertising products for each number of occupants registered by affiliated stores in the server. These consideration factors are illustrative and are not necessarily limited to the above factors.

The server can transmit the determined advertising information to the vehicle (S450).

The determined advertising information may include advertising information for occupants in each vehicle and advertising information for the total number of occupants in vehicles participating in the group driving.

FIG. 5 is a diagram showing an example in which advertising information is displayed on an output device according to an exemplary embodiment of the present disclosure.

In FIG. 5, it is assumed that a first vehicle with four occupants and a second vehicle with two occupants participate in group driving and include an area “A” as their destination.

Advertising information provided to the first vehicle may include advertising information 510 of an affiliated store A for the four occupants in the first vehicle and advertising information 520 of an affiliated store B for the six occupants in the vehicles participating in the group driving.

The two pieces of advertisement information may be advertisement information related to one area 500 defined as a preset area.

The controller 120 may be configured for controlling the output device 130 to display these two pieces of advertisement information using pins in different shapes or colors so that they may be distinguished from each other for the occupants.

For example, as shown in FIG. 5, the advertisement information 510 for store A may be display in the form of a circular pin, whereas the advertisement information 520 for store B may be display in the form of a square pin, thus being distinguished by different shapes.

It is possible to provide more appropriate advertising information that takes occupants into consideration in the case of group driving of a plurality of vehicles by providing advertising information based on the number of occupants in each vehicle and advertising information based on the total number of occupants of group driving.

The effects to be achieved in an exemplary embodiment of the present disclosure are not limited to the effects mentioned above, and other effects not mentioned will be clearly understood by those skilled in the art from the description below.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of providing advertising information to a vehicle participating in group driving of a plurality of vehicles, the method comprising:
transmitting, by a controller of the vehicle participating in the group driving, information on occupants of the vehicle to a server;
receiving, by the controller, the advertising information based on the information on occupants in the plurality of vehicles participating in the group driving from the server; and
outputting, by the controller, the received advertisement information through an output device.

2. The method of claim 1, further including collecting, by the controller, the information on occupants for the vehicle through a vehicle sensor after the vehicle participates in the group driving,
wherein the information on occupants includes information collected through the vehicle sensor.

3. The method of claim 1, wherein the outputting of the advertising information through the output device includes separately outputting advertisement information for occupants in each vehicle and advertisement information for all occupants in the vehicles participating in the group driving.

4. The method of claim 1, wherein the advertising information is determined by the server based on a destination or a route shared through the group driving.

5. The method of claim 1, wherein the advertising information is determined by the server based on advertising products for each piece of occupant information registered by affiliated stores in the server.

6. A method of providing information, the method comprising:
receiving, by a server, occupant information from each of a plurality of vehicles participating in group driving; and
transmitting, by the server, advertising information determined based on the received occupant information to the plurality of vehicles.

7. The method of claim 6, further including summing, by the server, numbers of occupants in the plurality of vehicles participating in the group driving and determining advertising information for occupants in each vehicle and advertising information for all occupants in the plurality of vehicles participating in the group driving based on a number of occupants in each vehicle after the receiving of the occupant information from each of the plurality of vehicles participating in the group driving.

8. The method of claim 6, further including determining, by the server, the advertising information based on a destination or a route shared through the group driving after the receiving of the occupant information from each of the plurality of vehicles participating in the group driving.

9. The method of claim 6, further including determining the advertisement information based on advertisement products for each piece of occupant information registered by each affiliated store in the server after the receiving of the occupant information from each of the plurality of vehicles participating in the group driving.

10. A vehicle comprising:
an output device; and
a controller operatively connected to the output device and configured to transmit information on occupants in the vehicle to a server in response that the vehicle participates in group driving, receive advertising information based on information on occupants in vehicles participating in group driving from the server, and to perform control so that the received advertising information is output through the output device.

11. The vehicle of claim 10, further including a vehicle sensor,
wherein the controller is further configured to collect the information on occupants through the vehicle sensor.

12. The vehicle of claim 10, wherein the advertising information is determined by the server based on a destination or a route shared through the group driving.

13. The vehicle of claim 10, wherein the advertising information is determined by the server based on advertising products for each piece of occupant information registered by affiliated stores in the server.

14. The vehicle of claim 10, wherein the controller is further configured to perform control so that advertising information corresponding to occupants in each vehicle of a plurality of vehicles and advertising information corresponding to all occupants in the plurality of vehicles participating in the group driving are separately output through the output device.

15. A server comprising:
a communication device; and
a controller configured to, in response that a plurality of vehicles participates in group driving, receive information on occupants in each vehicle in the plurality of vehicles through the communication device, and perform control so that advertising information determined based on the received information on occupants is transmitted to the plurality of vehicles through the communication device of the server.

16. The server of claim 15, wherein the controller is further configured to determine the advertisement information based on information on occupants in the plurality of vehicles participating in the group driving.

17. The server of claim 15, wherein the controller is further configured to determine the advertisement information based on a route or a destination shared by the plurality of vehicles participating in the group driving.

18. The server of claim 15, wherein each controller of the plurality of vehicles separately is configured to determine advertising information corresponding to occupants in each vehicle and advertising information corresponding to all occupants in the plurality of vehicles participating in the group driving.
